(19) United States
(12) Patent Application Publication
(10) Pub. No.: US 2025/0273716 A1
(43) Pub. Date: Aug. 28, 2025

(54) FUEL CELL SYSTEM AND DRYING METHOD FOR DRYING FUEL CELLS OF A FUEL CELL SYSTEM

(71) Applicant: Robert Bosch GmbH, Stuttgart (DE)

(72) Inventors: Mark Hellmann, Korntal (DE); Helerson Kemmer, Vaihingen (DE); Jochen Braun, Heimsheim (DE); Matthias Rink, Herrenberg (DE)

(21) Appl. No.: 18/858,685

(22) PCT Filed: Apr. 20, 2023
(86) PCT No.: PCT/EP2023/060273

§ 371 Date: Oct. 21, 2024

(30) Foreign Application Priority Data
Apr. 28, 2022 (DE) 10 2022 204 143.7

(51) Int. Cl. H01M 8/04828; H01M 8/04089; H01M 8/04111; H01M 8/04119; H01M 8/10

(52) U.S. Cl. CPC H01M 8/04835; H01M 8/04097; H01M 8/04111; H01M 8/04119; H01M 2008/1095

(57) ABSTRACT

The present invention relates to a fuel cell system (100) for converting energy. The fuel cell system (100) comprises a fuel cell stack (101) having a plurality of fuel cells, a recirculation path (105) fluidically connected to a cathode tract (103) of the fuel cell stack (101), an air system (111) for supplying air to the fuel cell system (100), at least one actuator (107, 123), and a computing unit (109).

### BACKGROUND

The present invention relates to a fuel cell system and a drying method for drying fuel cells of a fuel cell system.

A polymer electrolyte (PEM) fuel cell system consists of a plurality of subsystems, in particular an anode subsystem or a hydrogen system (HyS) for supplying hydrogen to an anode of the fuel cell system. To be able to adjust a hydrogen concentration in the HyS, a hydrogen dosing valve (HGI) and a so-called purge valve are used. The purge valve opens a connection to a mixing site downstream of a cathode of the fuel cell system. There, anode fluid separated by the purge valve consisting of hydrogen, nitrogen, and water vapor is mixed with the depleted air from the cathode.

An air system (AirS) supplies conditioned air to the cathode, i.e. air having set pressure, temperature and humidity. Often, the AirS comprises a bypass around the cathode to extend system operation by systemically extending a boundary of a compressor map.

A cooling system dissipates waste heat from a fuel cell stack of the fuel cell system to the surrounding area via a radiator. A limited operating temperature of a PEM fuel cell system and a limited cooling capacity of the cooling system may cause cooling problems in operation.

### SUMMARY

In the context of the present invention, a fuel cell system and a drying method for drying fuel cells of the fuel cell system are presented. In this context, features and details described in connection with the drying method according to the invention clearly also apply in connection with the fuel cell system according to the invention, and respectively vice versa, so that mutual reference to the individual considerations of the invention always is or can be made with respect to the disclosure.

The present invention serves to provide a robust fuel cell system. In particular, the present invention serves to minimize local drying out of fuel cells during a drying operation in preparation for a freeze start.

Therefore, according to a first consideration of the present invention, a fuel cell system is presented. The fuel cell system comprises a fuel cell stack having a plurality of fuel cells, a recirculation path fluidically connected to a cathode tract of the fuel cell stack, an air system for supplying air to the fuel cell system, at least one actuator, and a computing unit.

The at least one actuator is configured to allow a fluid in the recirculation path to circulate through the fuel cell stack in a first actuation state and to discharge fluid from the fuel cell stack into a surrounding area in a second actuation state.

The computing unit is configured to activate a homogenization operation of the fuel cell system to distribute water present in the fuel cell stack evenly in the fuel cell stack, and wherein the computing unit in the homogenization operation is configured to switch the at least one actuator to the first actuation state and to activate the air system.

An actuator, in the context of the present invention, is understood to mean an element switchable between a fluid-conducting state and a non-fluid-conducting state. For example, an actuator may be a valve, in particular a 3/2-way valve.

An air system in the context of the present invention is understood to be a system for conveying air. An air system may comprise a pump or booster or compressor, and/or an actuator, and/or a bypass conduit.

The present fuel cell system is based on a homogenization operation, wherein an actuator, by means of which the recirculation path of the present fuel cell system can be activated, that is, permeated by fluid, or deactivated, that is, prevented from being supplied with fluid, is switched to a first actuation state such that fluid flowing out of the fuel cell stack circulates in the recirculation path of the cathode tract.

Because the cathode tract of the fuel cell stack of the present fuel cell system is fluidically connected to the recirculation path, activating the recirculation path or switching the actuator to the first actuation state causes fluid to circulate through the recirculation path and through the fuel cell stack. Accordingly, fluids flowing in the recirculation path and the fuel cell stack, such as air, hydrogen, and water, mix together to a homogeneous mixture. Repeated or continuous permeating of fuel cells of the fuel cell stack by means of the homogeneous mixture causes a homogeneous distribution of water or moisture in the fuel cells so that local moisture differences in the fuel cells are avoided or minimized.

Because local moisture differences in a fuel cell result in particular in a drying process, such as is carried out in preparation for a freeze start, i.e. a start at outside temperatures below zero degrees Celsius, the homogenization operation is particularly suitable for use in a drying process, e.g. when switching off the fuel cell stack.

It may be provided that the computing unit is configured to activate homogenization operation prior to a bleed-down of the fuel cell stack.

By activating the homogenization operation prior to a bleed-down, i.e. a discharge of operational fluids from the fuel cell stack, electrical energy provided by the fuel cell stack can be used to operate the air system of the present fuel cell system and to activate the recirculation path, for example by feeding air into the recirculation path. Accordingly, the homogenization operation, if activated prior to the bleed-down, may be performed freely and without technical limitations.

It may further be provided that the fuel cell system recirculates only a portion of the cathode exhaust and discharges another portion to a surrounding area.

By partially recirculating, a load acting on the air system can be adjusted.

It may further be provided that the air system comprises an electrically driven turbomachine coupled to a battery, and the computing unit is configured to activate homogenization operation after a bleed-down of the fuel cell stack, particularly when the shutoff valves are closed.

By means of a turbomachine coupled to a battery, the recirculation path of the present fuel cell system can be activated or permeated with air, regardless of a state of the fuel cell stack. Accordingly, homogenization operation may be activated after a bleed-down or on a deactivated fuel cell stack. In this case, homogenization operation can be activated, for example, in a plurality of repetitions spaced apart in time, particularly by a plurality of minutes, such that accumulated moisture on the fuel cells of the fuel cell stack is distributed homogeneously several times.

It may further be provided that the fuel cell system comprises an anode recirculation system, and that the computing unit is configured to at least temporarily activate the anode recirculation system when the homogenization operation is activated.

It has surprisingly been discovered that activating an anode recirculation system and homogenization operation in parallel results in a particularly homogeneous drying behavior of the fuel cells.

It may further be provided that the computing unit is configured to alternately switch the at least one actuator to the first actuation state and the second actuation state in order to bring about alternating drying of the fuel cell stack and distributing water in the fuel cell stack.

By means of intermittent operation, wherein a change between drying operation and homogenization operation is made, a particularly uniform drying of the fuel cells can be achieved, wherein damage due to particularly dry regions at the cathode inlet is avoided in particular.

It may further be provided that the air system comprises a cathode recirculation fan and the computing unit is configured to activate the cathode recirculation fan when the homogenization operation is activated.

By means of a cathode recirculation fan, i.e. a fan operating independently of an air supply for supplying air to the fuel cell stack in normal operation or an additional fan unit, the recirculation operation can be adjusted freely and without technical restrictions due to requirements of the fuel cell system itself.

It may further be provided that the fuel cell system comprises a first actuator and a second actuator between which the cathode recirculation fan is disposed to minimize leakage from the outside through the cathode recirculation fan.

Because a fan typically comprises rotating parts and is connected to a surrounding area to draw in air, fans are susceptible to leakage or infiltration, such that shutting off the cathode recirculation fan by means of two actuators contributes to efficient and robust normal operation of the present fuel cell system.

It may further be provided that the fuel cell system comprises a first shutoff valve and a second shutoff valve, the first shutoff valve being disposed upstream of the recirculation path and the second shutoff valve being disposed downstream of the recirculation path.

By disposing shutoff valves of the fuel cell system so as to encompass or surround the recirculation path, homogenization operation can occur even when the shutoff valves are closed.

It may further be provided that the fuel cell system comprises a third shutoff valve disposed in the recirculation path upstream of the cathode tract to minimize leakage of the fuel cell system.

A third shutoff valve disposed in the recirculation path and upstream of the cathode tract maximizes leak-tightness of the fuel cell system in the off or deactivated state of the fuel cell system so that leakage is minimized.

It may further be provided that the air system comprises a first compressor and a further compressor, and the recirculation path opens into an airflow path between the first compressor and the further compressor.

By means of a multi-stage air system, a particularly energy-efficient homogenization operation can be achieved if only one stage of the air system for supplying air to the recirculation path is used.

According to a second consideration, the present invention relates to a drying method for drying fuel cells of a fuel cell system.

The drying process comprises activating a homogenization operation of the fuel cell system, moisture present in the fuel cell stack being evenly distributed in the fuel cell stack by the homogenization operation by switching at least one actuator of the fuel cell system to a first actuation state and activating an air system of the fuel cell system, the at least one actuator in the first actuation state allowing fluid flowing out of the fuel cell stack to circulate in a recirculation path of the fuel cell system fluidically connected to a cathode tract of the fuel cell stack, and, in a second actuation state, discharging fluid flowing out of the fuel cell stack to a surrounding area.

Further advantages, features, and details of the invention arise from the following description, in which exemplary embodiments of the invention are described in detail with reference to the drawings. In this context, the features mentioned in the claims and in the description can each be essential to the invention individually or in any combination.

### BRIEF DESCRIPTION OF THE DRAWINGS

Shown are:

FIG. 1 a schematic depiction of a potential embodiment of the present fuel cell system.

FIG. 2 a schematic depiction of a further potential embodiment of the present fuel cell system.

FIG. 3 a schematic depiction of another further schematic representation of a potential embodiment of the present fuel cell system.

FIG. 4 a depiction of a potential embodiment of the present drying method,

FIG. 5 a depiction of a further potential embodiment of the present drying method,

FIG. 6 a depiction of another further potential embodiment of the present drying method,

FIG. 7 a depiction of another further potential embodiment of the present drying method.

### DETAILED DESCRIPTION

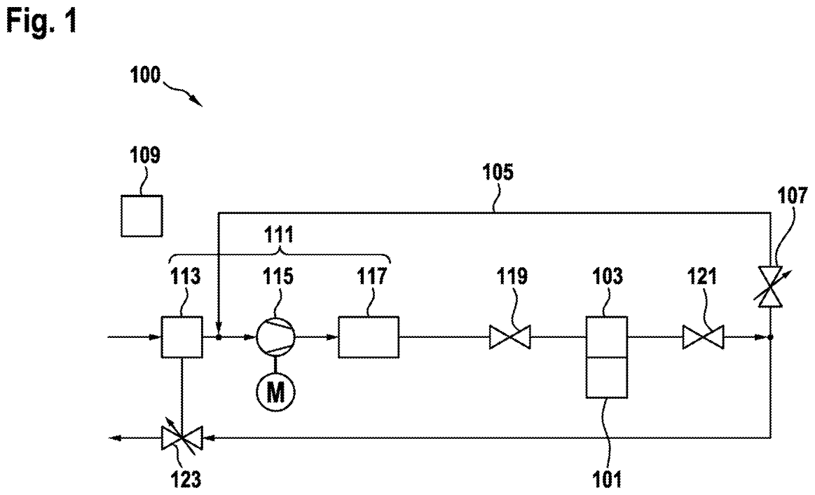

FIG. 1 shows a fuel cell system 100. The fuel cell system 100 comprises a fuel cell stack 101 having a cathode tract 103.

The cathode tract 103 is fluidically connected to a recirculation path 105 via a first actuator 107.

The fuel cell system 100 further comprises a computing unit 109. When a homogenization operation of the fuel cell system is activated, the computing unit 109 switches the first actuator 107 to a first actuation state and activates an air system 111 such that fluid present in the recirculation path is circulated through the recirculation path 105 and, as a result, through the fuel cell stack 101.

By circulating the fluid through the recirculation path 105 and the fuel cell stack 101, gases present in the fluid mix together to form a homogeneous mixture such that in particular a homogeneous moisture level is present in the recirculation path 105 and, as a result, in the fuel cell stack 101.

In the present case, the recirculation path 105 optionally opens between an air filter 113 and a compressor 115 of the air system 111, wherein the air system 111 comprises a further radiator 117.

In the present case, the cathode tract 103 can be optionally shut off by means of a first shutoff valve 119 and a second shutoff valve 121 to minimize leakage through the recirculation path 105.

By means of a second actuator 123, an exhaust path may be opened for discharging fluid into a surrounding area or shut off.

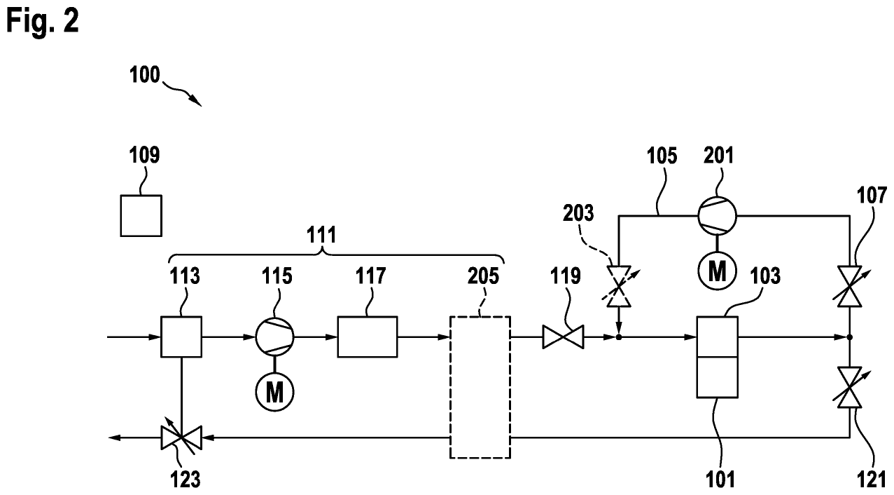

In FIG. 2, the fuel cell system 100 according to FIG. 1 has been extended by a cathode recirculation fan 201. The cathode recirculation fan 201 may be controlled independently of the air system 111, which in the present case comprises an optional humidifier 205. To this end, the cathode recirculation fan 201 may be coupled to, for example, an electrical battery to operate independently of an operating state of the fuel cell stack 101.

The cathode recirculation fan 201 allows for a compact design of the recirculation path 105, in the present case disposed between the shutoff valves 119 and 121, so that the entire recirculation path 105 can be shut off and accordingly protected from leakage from the outside.

An optional second actuator 203 allows the recirculation path 105 to be shut off independently of the shutoff valves 119 and 121, such that the recirculation path 105 can be activated or deactivated independently of an operating state of the shutoff valves 119 and 121, and the homogenization operation can be activated or deactivated correspondingly.

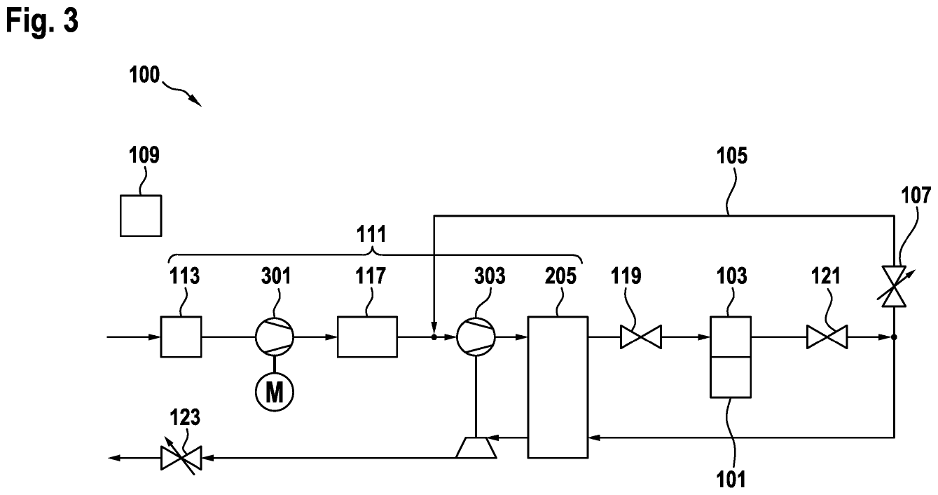

In FIG. 3, the fuel cell system 100 according to FIG. 1 has been extended by a two-stage air system 111. Accordingly, the air system 111 comprises a first compressor stage 301 driven by, for example, an electric motor, and a second compressor stage 303 driven by, for example, an exhaust gas enthalpy.

Here, the recirculation path 105 opens up between the two compressor stages 301 and 303 at an intermediate pressure level, leading to an increase in efficiency of the fuel cell system, because the first compressor stage 301 can operate independently of the homogenization operation, i.e. independently of the recirculation flow rate of the homogenization operation.

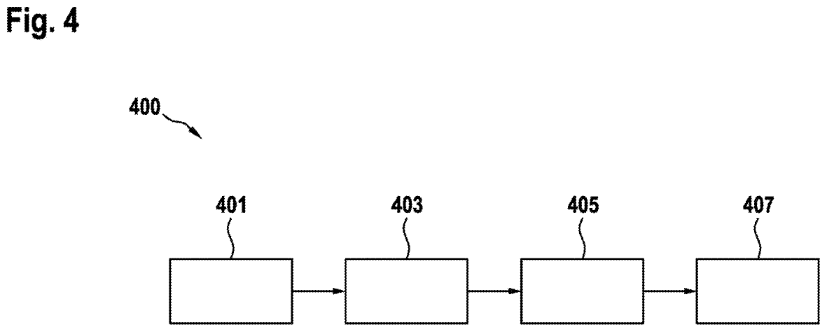

In FIG. 4, a drying method 400 is shown. The drying method 400 starts from initial normal operation 401 of a fuel cell system. In preparation for a freeze start, in a drying step 403, a drying procedure for drying fuel cells of the fuel cell system is initiated in which air passes through the fuel cells.

In an activation step 405, in order to avoid local drying out of the fuel cells, a homogenization operation of the fuel cell system is activated, by means of which moisture present in the fuel cell stack is evenly distributed in the fuel cell stack, by switching at least one actuator of the fuel cell system to a first actuation state and activating an air system of the fuel cell system,
wherein the at least one actuator, in the first actuation state, circulates fluid flowing out the fuel cell stack in a recirculating path of the fuel cell system fluidically connected to a cathode tract of the fuel cell stack, and in a second actuation state, discharges fluid flowing out of the fuel cell stack into a surrounding area.

The activation step 405 is carried out, for example, at time after the drying step 403 or during the drying step 403.

In a deactivation step 407, the fuel cell system is fully deactivated, resulting in, for example, a bleed-down of a fuel cell stack of the fuel cell system.

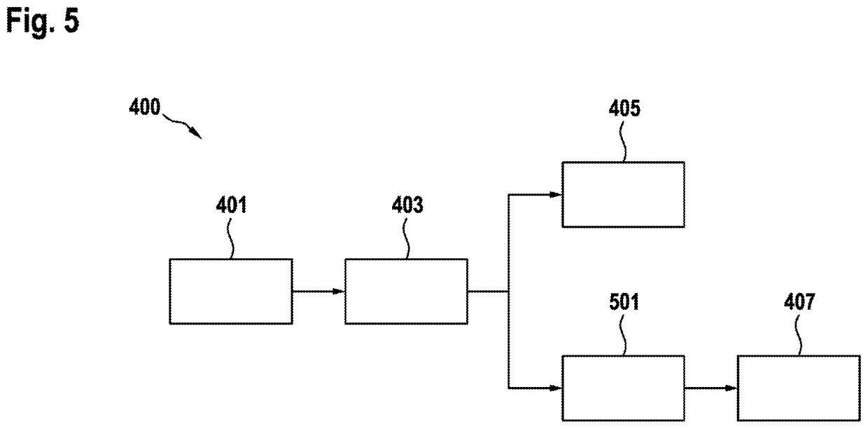

FIG. 5 shows an embodiment of the drying process 400 in which the activation step 405 takes place in parallel to a bleed-down 501 of the fuel cell stack, for example, by using a recirculation fan supplied with electrical power by a battery.

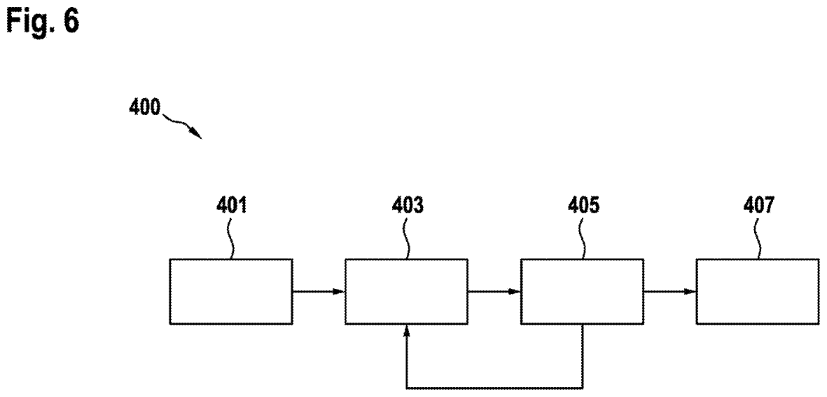

FIG. 6 shows an embodiment of the drying process 400 in which the activation step 405 is repeated, in particular repeated alternately with the drying step 403, in order to avoid too severely drying out of fuel cells of the fuel cell system due to too long drying times.

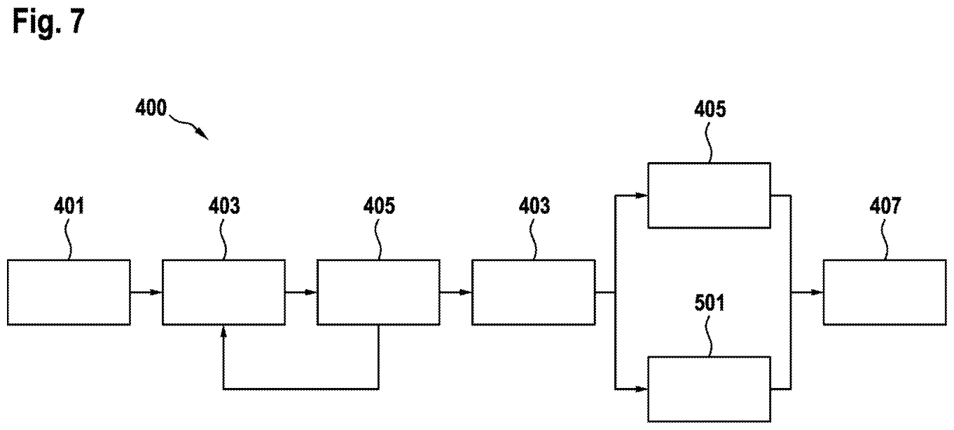

FIG. 7 shows a combination of the embodiments of the drying process 400 according to FIGS. 5 and 6, in which the activation step 405 both takes place in parallel to a bleed-down 501 of the fuel cell stack and is repeated alternately with the drying step 403.

1. A fuel cell system (100) for converting energy,
wherein the fuel cell system (100) comprises the following:
a fuel cell stack (101) having a plurality of fuel cells,
a recirculation path (105) fluidically connected to a cathode tract (103) of the fuel cell stack (101),
an air system (111) for supplying air to the fuel cell system (100),
at least one actuator (107, 123), and
a computing unit (109),
wherein the at least one actuator (107, 123) is configured to circulate a fluid in the recirculation path (105) through the fuel cell stack (101) in a first actuation state and to discharge fluid flowing from the fuel cell stack (101) into a surrounding area in a second actuation state,
wherein the computing unit (109) is configured to activate a homogenization operation of the fuel cell system to distribute water present in the fuel cell stack (101) evenly in the fuel cell stack (101), and
wherein in the homogenization operation the computing unit (109) is configured to switch the at least one actuator (107, 123) to the first actuation state and to activate the air system (111).

2. The fuel cell system (100) according to claim 1,
wherein
the computing unit (109) is configured to activate homogenization operation prior to a bleed-down of the fuel cell stack (101).

3. The fuel cell system (100) according to claim 1,
wherein
in the first actuation state, the fuel cell system (100) recirculates only a portion of the cathode exhaust and discharges another portion to a surrounding area.

4. The fuel cell system (100) according to claim 3,
wherein
the air system (111) comprises an electrically driven turbomachine coupled to a battery, and the computing unit is configured to activate homogenization operation after a bleed-down of the fuel cell stack (101), when the shutoff valves (119, 121) are closed.

5. The fuel cell system (100) according to claim 1,
wherein
the fuel cell system (100) comprises an anode recirculation system and the computing unit (109) is configured to at least temporarily activate the anode recirculation system when the homogenization operation is activated.

6. The fuel cell system (100) according to claim 1,
wherein
the computing unit (109) is configured to alternately switch the at least one actuator (107, 123) to the first actuation state and the second actuation state to bring about alternating drying of the fuel cell stack (1019) and distributing water in the fuel cell stack (101).

7. The fuel cell system (100) according to claim 1,
wherein
the air system (111) comprises a cathode recirculation fan (201) and the computing unit (109) is configured to activate the cathode recirculation fan (201) when the homogenization operation is activated.

8. The fuel cell system (100) according to claim 7,
wherein
the fuel cell system (100) comprises a first actuator (119) and a second actuator (121) between which the cathode recirculation fan (201) is disposed to minimize the impact of leakage through the cathode recirculation fan (201) on the fuel cell stack (101) when shut down.

9. The fuel cell system (100) according to claim 1,
wherein
the fuel cell system (100) comprises a first shutoff valve (119) and a second shutoff valve (121), wherein the first shutoff valve (119) is disposed upstream of the recirculation path (105) and the second shutoff valve (121) is disposed downstream of the recirculation path (105).

10. The fuel cell system (100) according to claim 9,
wherein
the fuel cell system (100) comprises a third shutoff valve disposed in the recirculation path (105) upstream of the cathode tract (103) to minimize leakage of the fuel cell system (100).

11. The fuel cell system (100) according to claim 1,
wherein
the air system (111) comprises a first compressor stage (301) and a further compressor stage (303), and the recirculation path (105) opens into an airflow path between the first compressor stage (301) and the further compressor stage (303).

12. A drying method (400) for drying fuel cells of a fuel cell system (100),
wherein the drying method (400) comprises:
activating (403), via a computer, a homogenization operation of the fuel cell system (100), wherein moisture present in the fuel cells is evenly distributed by the homogenization operation by switching at least one actuator (107, 123) of the fuel cell system (100) to a first actuation state and activating an air system (111) of the fuel cell system (100),
wherein the at least one actuator (107, 123) in the first actuation state allows fluid flowing out of a fuel cell stack (101) of the fuel cell system (100) to circulate in a recirculation path (105) of the fuel cell system (100) fluidically connected to a cathode tract (103) of the fuel cell stack (101), and in a second actuation state discharges fluid flowing out of the fuel cell stack (101) to a surrounding area.
